(19) United States
(12) Patent Application Publication
(10) Pub. No.: US 2016/0319675 A1
(43) Pub. Date: Nov. 3, 2016

(54) ROTOR BLADE FOR A GAS TURBINE

(71) Applicant: Siemens Aktiengesellschaft, Mulheim (DE)

(72) Inventors: Fathi Ahmad, Kaarst (DE); Horst-Michael Dreher, Berlin (DE); Thorsten Mattheis, Mulheim (DE); Christian Menke, Essen (DE)

(73) Assignee: Siemens Aktiengesellschaft, Munich (DE)

(21) Appl. No.: 15/135,727

(22) Filed: Apr. 22, 2016

(30) Foreign Application Priority Data
Apr. 28, 2015 (EP) 15165406.8

(51) Int. Cl. F01D 5/20; F01D 5/18

(52) U.S. Cl. CPC F01D 5/20; F01D 5/187; F05D 2220/32; F05D 2240/307; F05D 2260/20

(57) ABSTRACT

A rotor blade for a gas turbine has a pressure-side wall and a suction-side wall, a tip cap, a cavity which is formed by the inner surface of the pressure-side wall, the suction-side wall and the tip cap, and a squealer which extends radially from the pressure-side and suction-side walls, a half-space formed by the outer surface of the tip cap and the squealer, and a cooling channel which leads from the cavity to the outside of the squealer. The tip cap has a recess which extends from the half-space into the tip cap such that the recess divides the cooling channel into a first part that communicates with the cavity and a second part that communicates with the outside space.

### CROSS REFERENCE TO RELATED APPLICATIONS

This application claims the benefit of European Application No. EP15165406 filed 28 Apr. 2015, incorporated by reference herein in its entirety.

### FIELD OF INVENTION

The invention relates to a rotor blade for a gas turbine, comprising a pressure-side wall and a suction-side wall, a tip cap, a cavity which is formed by the inner surface of the pressure-side wall, the suction-side wall and the tip cap, and a squealer which extends radially from the pressure-side and suction-side walls, a half-space formed by the outer surface of the tip cap and the squealer, and a cooling channel which leads from the cavity to the squealer.

### BACKGROUND OF INVENTION

Rotor blades of the abovementioned type serve in gas turbines for converting the energy of a hot gas stream into rotational energy. They typically have a blade airfoil through which pass one or more cavities for the supply of cooling air, and which has a pressure-side and a suction-side wall and is closed at its tip by a tip cap. Frequently, there is arranged on the tip cap a peripheral squealer which extends in the radial direction (relative to the axis of the gas turbine) and which extends the pressure-side and suction-side walls in the radial direction.

Currently, turbine rotor blades are produced by casting, in one piece and made of one material. They are generally cooled during operation in order to protect the material of the blades from the high gas temperatures and to prevent oxidation of the blade material. A proven and successful cooling construction for turbine blades is internal cooling. In that context, a liquid or gaseous cooling fluid generally air which is bled from the compressor of the turbine flows in the above-described cavities.

This has the problem that the described squealer has relatively thin walls and is relatively remote from the cooling air inside the blade. For that reason, it is particularly exposed to the high temperatures of the gas stream. In order to ensure cooling of the tip region, cooling channels lead from the cavity within the blade, through the tip cap to the outside of the squealer. Cooling fluid exits through these cooling channels and thus cools the squealer. Such an arrangement is for example known from EP 1 057 970 B1.

Moreover, EP 1 267 041 B1 discloses the introduction, into the inner side, i.e. the side facing the half-space, of the squealer, of a recess which interrupts the cooling channel. This does indeed improve the cooling effect. However, it has the disadvantage of reducing the stability of the squealer. This limits the possible length of the recess.

### SUMMARY OF INVENTION

The invention now has an object of specifying a rotor blade of the type mentioned in the introduction, which has still better cooling of the squealer and at the same time great stability and service life.

This object is achieved, according to the invention, in that the tip cap has a recess which extends from the half-space into the tip cap such that the recess divides the cooling channel into a first part that communicates with the cavity and a second part that communicates with the outside space.

In that context, the invention proceeds from the consideration that the service life of the rotor blade can be increased even further by providing a recess which interrupts the cooling channel but which does not reduce the stability of the squealer. To that end, the recess extends radially into the tip cap and thus does not reduce the thickness of the squealer. The recess extends into the cooling channels, which extend from the cavity within the blade to the outside of the squealer, such that these cooling channels are divided into a first and a second part.

In that case, the first part advantageously has an outlet opening in the recess and/or the second part advantageously has an outlet opening on the outside of the squealer. Thus, the cooling fluid flow from the cavity in the rotor blade first enters the recess where it cools the inside of the half-space. Here, cooling is highly effective. Only then does it flow on through the second part to the outside of the squealer. Due to the pressure differences which prevail in operation, there is in this case also no risk of flow reversal, i.e. no hot gas enters the half-space through the second part.

In one advantageous configuration of the rotor blade, the cooling channel is linear. This is the case for the entire cooling channel, i.e. the first and second parts lie on a common straight line. On one hand, this permits better through-flow of the cooling fluid from the first into the second part of the cooling channel. On the other hand, however, it makes the cooling channel particularly simple to introduce, and specifically both the first and second parts can be introduced in one operation, advantageously by means of laser drilling. The laser is mounted on the outside of the squealer and drills through the recess into the cavity within the rotor blade.

In another advantageous embodiment of the rotor blade, the recess extends in the manner of a groove along the pressure-side wall or along the suction-side wall of the rotor blade. This achieves particularly even cooling since the cooling fluid can spread from the cooling channel along the length of the groove and can provide even cooling of the squealer. Of particular advantage with respect to the pressure conditions is for the recess to extend along the suction-side wall.

In that case, advantageously, one side wall of the recess transitions straight into the inside of the pressure-side or suction-side wall. On one hand, this permits a particularly simple casting mold, and on the other hand it further improves the cooling effect of the cooling fluid in the recess or groove on the squealer.

In one advantageous configuration, the rotor blade has multiple cooling channels that lead from the cavity to the outside of the squealer, and the recess divides each of the multiple cooling channels into a first part that communicates with the cavity and a second part that communicates with the outside space. In that context, the cooling channels are identical. The provision of multiple cooling channels of this type further improves the cooling effect.

A rotor for a gas turbine advantageously comprises such a rotor blade.

A gas turbine advantageously comprises such a rotor.

A power plant advantageously comprises such a gas turbine.

The advantages obtained with the invention consist in particular in that introducing into the tip cap a radial recess which divides the cooling channels to the outside of the squealer achieves a particularly good cooling effect and at the same time high stability of the squealer. The recess serves to guarantee the cooling fluid outlet in spite of possible casting discrepancies during production of the rotor blade. In addition, the cooling fluid experiences less pressure loss. Service life is also increased, by virtue of the fact that cooling channels that discharge into the half-space discharge into the recess and are thus even better protected from external hot gas.

### BRIEF DESCRIPTION OF THE DRAWINGS

Exemplary embodiments of the invention will be explained in more detail with reference to drawings, in which:

FIG. 1 is a view, from the radial direction, of the tip of a rotor blade in a first embodiment,

FIG. 2 shows a cross section, along the line I-I, of the tip region of the rotor blade from FIG. 1,

FIG. 3 shows a cross section of the tip region of the rotor blade in a second embodiment, and

FIG. 4 shows a partial longitudinal section through a gas turbine.

### DETAILED DESCRIPTION OF INVENTION

In all figures, the same parts have been provided with the same reference signs.

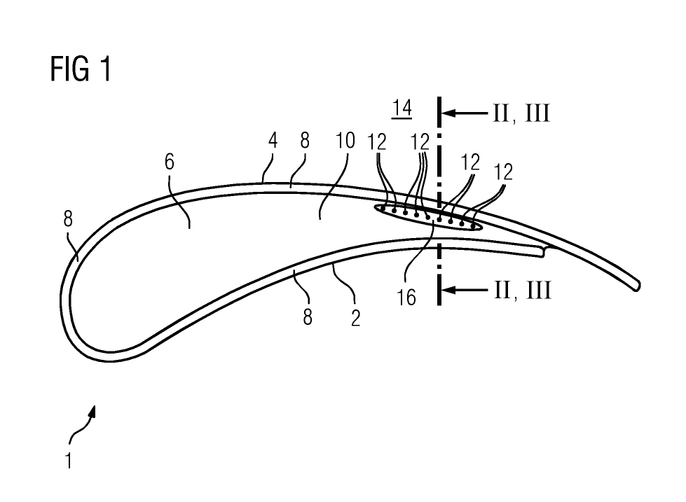

FIG. 1 is a view, from the radially outer direction, of a rotor blade 1. This rotor blade has a pressure-side wall 2, a suction-side wall 4 and a tip cap 6 at the radial end of the rotor blade 1. Within the rotor blade 1, the inner surface of the tip cap 6 and the inner surfaces of the pressure-side and suction-side walls 2, 4 form a cavity (not shown here). A cooling fluid generally air which is led from the compressor of the turbine circulates inside the cavity and cools the pressure- and suction-side walls 2, 4 from the inside by convection.

FIG. 1 shows, in particular, the tip region of the rotor blade 1, which comprises a squealer 8 that protects the tip region of the blade from damage in the event of contact with the casing of the gas turbine. The squealer 8 extends radially from the pressure- and suction-side walls 2, 4 at the same peripheral height. The squealer 8 forms, together with the tip cap 6, a half-space 10.

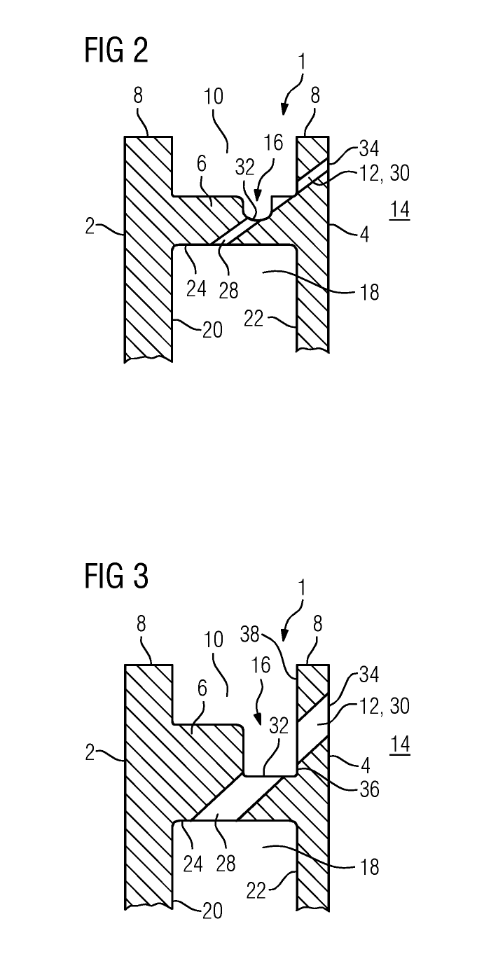

Multiple cooling channels 12 extend, from the cavity within the rotor blade, through the squealer 8 to that side of the latter facing the outside space 14. This is not shown in FIG. 1 and is shown more clearly by FIG. 2. The cooling fluid flows through these cooling channels 12 and cools the squealer 8 by internal cooling. The cooling fluid then exits from the cooling channels 12 through the outlet openings on the outer side, cools the squealer 8 by flowing around its exterior, and finally mixes with the leakage flow of the gas turbine.

A recess 16, which extends radially inward and in the manner of a groove parallel to the suction-side wall 4, is introduced into the tip cap 6. The recess 16 divides the cooling channels 12 close to the suction-side wall 4. This is explained below with reference to FIG. 2.

FIG. 2 shows the cross section, along the line I-I, of the tip region of the rotor blade 1, with the pressure-side wall 2 and the suction-side wall 4. As is apparent here, the cavity 18 in the rotor blade 1 is formed by the inner surfaces 20, 22 of the pressure- and, respectively, suction-side walls 2, 4, and by the inner surface 24 of the tip cap 6. A cooling channel 12 extends, as described, from the cavity 18 to the outside of the squealer 8. It is entirely linear and is introduced by laser drilling. The cooling channel 12 is divided, by the recess 16, into a first part 28, which extends from the cavity 18 to an outlet opening 32 in the recess 16, and a second part 30, which extends from the recess 16 to the outlet opening 34 on the outside of the squealer 8.

All of the cooling channels 12 shown in FIG. 1 are identical and thus discharge into the recess 16. In the present case, the recess 16 is designed with a rounded or curved side wall which most expediently is produced by casting.

The second embodiment as shown in FIG. 3, which will be explained only in terms of its differences with respect to FIG. 2, has a rectangular recess 16 which is produced most economically by means of chip-removing shaping. Both shapes are suitable from the point of view of the cooling fluid flow and of the effectiveness of the cooling. In the embodiment of FIG. 3, it is also the case that one side wall 36 of the recess 16 transitions straight into the inside 38 of the squealer 8 on the suction-side wall 4.

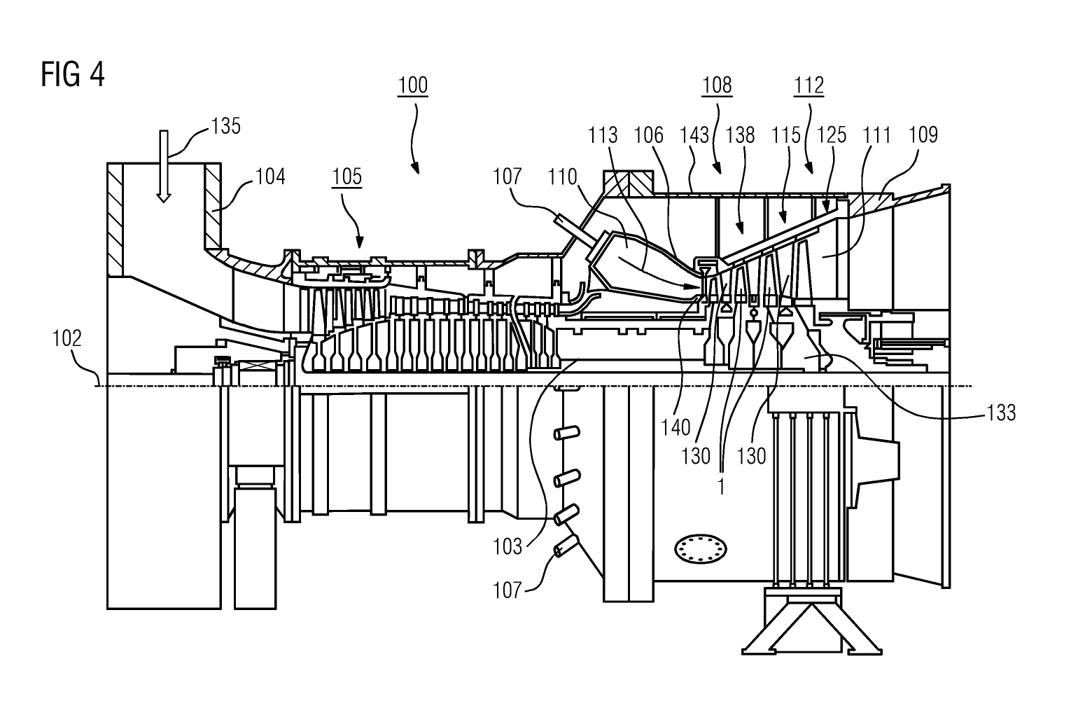

Finally, FIG. 4 shows a partial longitudinal section through a gas turbine 100. A turbine is a turbomachine which converts the internal energy (enthalpy) of a flowing fluid (liquid or gas) into rotational energy and finally into mechanical drive energy.

In the interior, the gas turbine 100 has a rotor 103 which is mounted such that it can rotate about an axis of rotation 102 (axial direction) and is also referred to as the turbine rotor. An intake housing 104, a compressor 105, a toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with an annular hot gas duct 111. There, for example four series-connected turbine stages 112 form the turbine 108. Each turbine stage 112 is formed from two blade rings. As seen in the direction of flow of a working medium 113, in the hot gas duct 111 a row of stator blades 115 is followed by a row 125 formed from rotor blades 1. The blades 120, 130 have a slightly curved profile, similar to an aircraft airfoil.

In that context, the stator blades 130 are secured to the stator 143, whereas the rotor blades 120 of a row 125 are fitted to the rotor 103 by means of a turbine disk 133. The rotor blades 1 are thus a constituent part of the rotor or spool 103. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot gas duct 111 past the stator blades 130 and the rotor blades 1.

As the fluid flow flows—as turbulence-free and laminar as possible—around the turbine blades 1, 130, part of the internal energy of the fluid flow is extracted therefrom and is taken up by the rotor blades 1 of the turbine 108. These then set the rotor 103 in rotation, first driving the compressor 105. The useful power is provided to the generator (not shown).

While the gas turbine 100 is operating, the components which are exposed to the hot working medium 113 are subject to thermal stresses. The stator blades 130 and rotor blades 1 of the first turbine stage 112, as seen in the direction of flow of the working medium 113, together with the heat shield tiles which line the annular combustion chamber 106, are subject to the highest thermal stresses. The high loads require extremely resistant materials. The turbine blades 1, 130 are therefore made of titanium alloys, nickel superalloys or tungsten-molybdenum alloys. In order to increase their resistance with respect to temperatures and erosion such as pitting, the blades are protected by means of coatings against corrosion (MCrAlX; M=Fe, Co, Ni, rare earths) and heat (thermal barrier coating, for example ZrO2, Y2O4—ZrO2). The coating for heat protection is termed thermal barrier coating or TBC for short. Other measures to provide the blades with greater heat resistance consist of sophisticated cooling channel systems. This technique is used both in stator blades and in rotor blades 1, 130.

Each stator blade 130 has a stator blade root (not shown here), also termed platform, which faces the inner casing 138 of the turbine 108, and a stator blade tip, which is at the opposite end from the stator blade root. The stator blade tip faces the rotor 103 and is fixed to a sealing ring 140 of the stator 143. In that context, each sealing ring 140 surrounds the shaft of the rotor 103. Also, each rotor blade 1 has such a rotor blade root but ends in a rotor blade tip. This tip is configured in accordance with an embodiment shown in FIG. 1 to FIG. 3.

1. A rotor blade for a gas turbine, comprising
a pressure-side wall and a suction-side wall,
a tip cap,
a cavity which is formed by the inner surface of the pressure-side wall, the suction-side wall and the tip cap, and
a squealer which extends radially from the pressure-side and suction-side walls,
a half-space formed by the outer surface of the tip cap and the squealer, and
a cooling channel which leads from the cavity to the outside of the squealer, characterized in that
the tip cap has a recess which extends from the half-space into the tip cap such that the recess divides the cooling channel into a first part that communicates with the cavity and a second part that communicates with the outside space.

2. The rotor blade as claimed in claim 1,
wherein the first part has an outlet opening in the recess.

3. The rotor blade as claimed in claim 1,
wherein the second part has an outlet opening on the outside of the squealer.

4. The rotor blade as claimed in claim 1,
wherein the cooling channel is linear.

5. The rotor blade as claimed in claim 1,
wherein the recess extends in the manner of a groove along the pressure-side wall or along the suction-side wall of the rotor blade.

6. The rotor blade as claimed in claim 5,
wherein one side wall of the recess transitions straight into the inside of the squealer.

7. The rotor blade as claimed in claim 5, further comprising:
multiple cooling channels that lead from the cavity to the outside of the squealer, and
wherein the recess divides each of the multiple cooling channels into a first part that communicates with the cavity and a second part that communicates with the outside space.

8. A rotor for a gas turbine, comprising:
a rotor blade as claimed in claim 1.

9. A gas turbine having comprising:
a rotor as claimed in claim 8.

10. A power plant having comprising:
a gas turbine as claimed in claim 9.
